(19) United States
(12) Patent Application Publication
(10) Pub. No.: US 2003/0191843 A1
(43) Pub. Date: Oct. 9, 2003

(54) Secure network connection for devices on a private network

(76) Inventors: Joel Balissat, La Gaude (FR); Claude Galand, Saint-Paul (FR); Jean-Francois Le Pennec, Nice (FR); Jean-Marie Sommerlatt, Cagnes sur Mer (FR)

Correspondence Address: COOLEY GODWARD LLP, ATTN: Patent Group, One Freedom Square, Reston Town Center, 11951 Freedom Drive, Reston, VA, 20190-5601, US

(21) Appl. No.: 10/115,408

(22) Filed: Apr. 4, 2002

(51) Int. Cl. G06F 15/16; H04L 9/32; G06F 11/30; G06F 12/14

(52) U.S. Cl. 709/227; 713/201

(57) ABSTRACT

A method and system for providing secure network connections are provided. When a device resides on a private network such that its address is not commonly available to other devices via a public network, a gateway, firewall or similar device can be used to preserve the address of the private network device in confidence while still allowing a secure, end-to-end connection between the public and private network devices. The gateway or similar device may negotiate separate secure connections, such as Security Associations, with each of the public and private network devices. In this way, encryption parameters of those two devices can be exchanged even though neither need be knowledgeable of the other's actual address. Moreover, the gateway or similar device can perform this function without itself gaining access to the content being transmitted between the public and private network devices. Additionally, the gateway or similar device can also be used to forward data between the public and private network devices once a secure tunnel has been established therebetween.

### BACKGROUND OF THE INVENTION

1. Field of the Invention

The present invention relates to the formation and use of secure network connections. More specifically, the present invention relates to forming secure network connections for devices located within a private network.

2. Description of the Related Art

Computer networks, and in particular Wide Area Networks (WANs) such as the Internet, provide opportunities for the misuse and abuse of communications traveling thereover. For example, two users communicating via the WAN may have their communications intercepted and/or altered. Also, it is possible for one user to misrepresent his or her identity to another user. As a final example, a user may utilize network resources and communications to disrupt all or part of the network.

Thus, there is a need for both privacy and authentication between users of the WAN communicating with one another. In other words, users should be able to rely on the fact that their transmissions will not be intercepted or altered, and that transmissions from someone purporting to be a particular user do in fact originate from that user.

One type of defense against ill-intentioned uses of the WAN is a device operating at the edge of a private network, such as a Gateway, Firewall or some other dedicated network appliance. Such a device operates to filter transmissions between the private network and the WAN and/or to protect the transmissions that do go through by encrypting/decrypting (i.e., encoding/decoding) those transmissions.

Other related types of defenses function by establishing the identity of a sender and/or recipient before sending/receiving a communication. Still other defenses include establishing a secure channel between two communicating devices.

A particular conventional protocol for providing security between devices operating over an Internet Protocol (IP) network is known as IPsec. Short for IP Security, IPsec is a set of protocols supporting the secure exchange of IP packets at a network layer. Two of the protocols used are the Authentication Header protocol (AH) and the Encapsulating Security Payload protocol (ESP).

AH is designed to ensure that transmitted packets are not altered during transit over the network, but does not protect the contents of the packets from being viewed by other users of the network such as intercepting parties. ESP, on the other hand, ensures the confidentiality of the packet contents. ESP provides an optional authentication mechanism; however, this mechanism is only for authenticating the data payload of the packet (and associated ESP headers/trailers). Therefore, ESP does not authenticate an IP Header of a packet indicating an original IP address on the network from which the packet originated. It is also possible to use AH and ESP in conjunction with one another, in order to achieve the advantages of both.

Whether using AH or ESP, IPsec operates in either transport or tunnel mode. Transport mode is often used in host-to-host communications; i.e., when the peer devices are the endpoints of communication. Transport mode is most useful within an overall IPsec environment including the two endpoints. Tunnel mode is typically used in communications between an IPsec-protected system and some other endpoint, such as communications sent from a private network over the Internet. In tunnel mode, the payload of a secured IP packet carries another packet containing the actual data payload to be transmitted.

A common use of the tunnel mode is to implement a Virtual Private Network (VPN). VPNs are networks that use publicly-available network resources, such as the Internet, to construct a network accessible only by selected parties. For example, a company may create its own version of a Local Area Network (LAN) using the Internet, or a worker working from a remote location may be able to utilize company resources at a company headquarters.

In order to implement the various protocols and modes of IPsec such as those discussed above, a security association (SA) is typically formed. An IPsec SA is essentially a contract or agreement between parties defining conditions according to which the two parties will communicate. For example, an IPsec SA is typically a one-way connection that defines, for example, encryption algorithms to be used during information exchange. SAs are defined by such parameters as an IP destination address and a security protocol identifier (e.g., AH or ESP). SAs typically include a security parameter index (SPI), which is a 32 bit identification number.

If an IPsec SA is considered a contract or agreement, then the terms thereof can be considered to be negotiated by a separate protocol (or manually). In other words, both communicating parties must agree on actions that will be taken on communicated packets in order to encrypt/decrypt those packets. One such protocol is known as the Internet Security Association and Key Management Protocol (ISAKMP), and one implementation of ISAKMP is known as the Internet Key Exchange (IKE).

IKE typically operates in two phases. In a first phase, parties agree as to how to protect further negotiation traffic. For example, IKE may authenticate a sender by virtue of, for example, public key encryption, also known as Diffie-Hellman encryption. In public key encryption, each user generates a public and private key, where the public key is then sent to the other party. When each user combines his own private key with the other's public key (and perhaps additional information), they each obtain an identical secret key. This secret key serves as a basis for deriving subsequent cryptographic keys.

In this way, a first user can encrypt a message using the second user's public key, and then only the second user (using his own private key) will be able to decrypt and receive the message.

Also, a first user can use his private key to sign a message and the second user, with the first user's public key, can receive and authenticate the transmitted message. Thus, the first user is authenticated to the second user as the one who sent the transmission; i.e., a “digital signature.”

This latter methodology, however, does nothing to guard against the eventuality that a third party is merely pretending to be the sender (i.e., the first user) when the keys were generated in the first place. Therefore, independent and trusted Certification Authorities (CAs) exist which issue digital certificates verifying the association of a public key with a particular user, along with other identifying information.

There are two primary modes for phase 1 of IKE: main mode and aggressive mode. Main mode, generally speaking, is a more involved but more secure method. Aggressive mode, though faster, sacrifices identity protection; however, using the public key encryption methodology just discussed obviates the need for this feature.

In a second phase, IKE negotiates the actual IPsec SA (over which the actual application layer data exchanges will take place) by setting up the encryption/authentication keys for the AH and/or ESP protocols. In particular, “quick mode” negotiates the SAs for general purpose IPsec communications. Also, it should be noted that, typically, only one phase 1 negotiation is needed for an associated plurality of phase 2 operations by a plurality of peer devices. This allows the multiple peer devices to each take advantage of the phase 1 proceedings, thereby establishing secure connections more quickly and more easily.

As shown in the above discussion, therefore, various solutions exist for implementing private and authenticated network communications. Within these solutions, for example, a protocol such as IPsec requires that the devices between which a secure connection will be established are available over an IP environment. In other words, the devices should have their IP addresses available as a registered, routable address.

However, it is often the case that a device's IP address is not available to the entire WAN. For example, a device may be located within a private network and protected by an external Gateway or Firewall, such as might be contained within an Internet Service Provider (ISP) or corporate sponsor of the device. Although many such Gateways provide a Network Address Translation (NAT) function, which differentiates between an internal and external address of each device within the private network, this function does not provide a means for a remote device to access an actual IP address of a member device of the private network through the Gateway.

Although some current solutions to this scenario utilizing the above technologies are available, none are completely suitable. For example, as demonstrated in FIG. 1A (where no NAT is implemented), it is possible to simply disable the filtering feature of a Firewall with respect to the set of devices in question. In FIG. 1A, device 100 on WAN 120 is provided with an address of (and access to) device 140 on private network 130.

Therefore, devices 100 and 140 can establish an SA and tunnel connection as shown; i.e., those devices are both the SA endpoints and the tunnel endpoints, and can communicate with one another in a secure manner.

However, this solution has the obvious disadvantage of creating a hole in the network security. For example, once access to device 140 is provided to users of WAN 120, any user of WAN 120 may access that device. Such access may then lead to various problems in protecting device 140 or any device on private network 130.

Another exemplary conventional solution is to establish a secure channel between the remote device and the Gateway (the address of which is publicly available). Then, decryption can occur at the Gateway, after which the decrypted packets can be forwarded to the recipient device within the private network. However, this solution suffers from the fact that operators of the Gateway will have access to the decrypted information intended for the recipient device. In other words, this solution can be used in conjunction with a NAT Gateway, but such a device is not a customer device; it is a service provider device, and, as such, it is not typically secure or desirable (from the customer's viewpoint) to allow access to decrypted packets there.

Therefore, what is needed is a system and method for establishing a secure, manageable connection between a private network device and a second device, even over a WAN such as the Internet.

### SUMMARY OF THE INVENTION

One embodiment of the present invention relates to a method for implementing secure network communications between a first device and a second device, where at least one of the devices is communicating with a public network via a separate computer. The method comprises receiving a request for a first secure connection from the first device, masking an address of the first device with respect to the second device and initiating a second secure connection between the separate computer and the second device. According to this method, the first and second secure connections enable the secure network communications between the first and second devices.

Another embodiment of the present invention relate to a virtual peer device for implementing a secure network connection between a first and second device, where at least one of the devices is a private network device communicating with a public network via the virtual peer device. In this embodiment, the virtual peer device comprises a means for receiving a request for a first connection from the first device, a means for requesting a second connection with the second device, means for forwarding encryption parameters between the two devices, to thereby establish the first and second connections and means for establishing the secure connection based on the first and second connections.

Another embodiment of the present invention relates to an article of manufacture comprising a computer readable medium having stored therein a computer program carrying out a method for implementing a secure connection between two devices. In this embodiment, the computer program comprises a first code segment for establishing a device address associated with the article of manufacture, a second code segment for establishing a first link between a first device and the device address, a third code segment for establishing a second link between a second device and the device address, a fourth code segment for exchanging encryption parameters associated with each of the first and second device via the first and second link and a fifth code segment for establishing the secure connection based on the encryption parameters.

Another embodiment of the present invention relates to a method of transmitting data. This method comprises negotiating a first security association between a first device and a second device, negotiating a second security association between a second device and a third device that is independent of the first security association and transmitting data inaccessible to said second device between the first and third devices via the second device.

The features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A demonstrates a prior art networking environment.

FIG. 1B demonstrates a network environment in which one embodiment of the present invention might operate, including a gateway computer operating on the edge of a private network and communicating with another device via a public WAN.

FIG. 2 demonstrates a methodology for negotiating a pair of Security Associations (SAs) according to one embodiment of the invention.

FIG. 3 describes an embodiment of the invention in which various types of IPsec traffic is relayed through a gateway computer both ways between a pair of devices.

FIGS. 4A-4D describe structures of exemplary IPsec packets that may be transported according to various embodiments of the invention.

FIGS. 5A-5C demonstrate various simplified views of IP header packet structures for tunnel head portions such as those shown in FIGS. 4A-D.

FIGS. 6A-6D describe exemplary certificate structures for each device type when certificates are used within the SA process.

FIG. 7 demonstrates exemplary process steps run by a gateway computer during a first phase of SA establishment.

FIG. 8 demonstrates exemplary process steps run by a gateway computer during a second phase of SA establishment.

### DETAILED DESCRIPTION

While the present invention is described below with respect to various exemplary embodiments, the present invention is not limited to only those embodiments that are disclosed. Other embodiments can be implemented by those skilled in the art without departing from the spirit and scope of the present invention.

In this regard, although IPsec is used herein to demonstrate an exemplary embodiment of the invention, it should be understood that the present invention can be utilized in the context of other conventional network security protocols, such as Layer 2 Tunneling Protocol (L2TP) and Point-to-point Tunneling Protocol (PPTP), as would be apparent. Similarly, other protocols/methodologies besides IKE and public key encryption exist which are useful in implementing network security protocols, and the present invention can be implemented in those environments as well.

Moreover, it should be noted that the terminology and associated definitions used herein are subject to some level of disagreement in the art, as is known. For example, some artisans will describe IKE as an instance of ISAKMP, whereas others will describe IKE as the combination of ISAKMP with certain other protocols. Such terminology and definitions are used singularly and consistently herein only for the purposes of clarity; therefore, it should be understood that such usage is designed merely to explain and not limit the present invention. Similarly, terms such as “encryption,” “encryption parameters” or any other term of art, unless otherwise specified or limited herein, are not intended to be re-defined to have a special meaning herein and should be given their broadest reasonable interpretations consistent with the conventional understanding in the art.

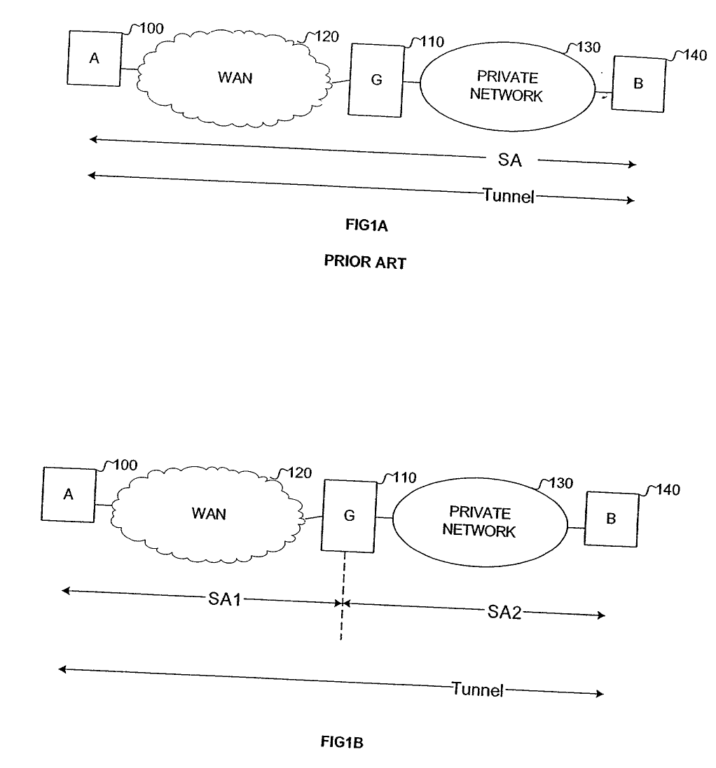

The present invention, in an exemplary embodiment, operates by modifying the functionality of a conventional Network Address Translation (NAT) Gateway operating on the edge of a private network and communicating with another device via a public WAN, such as the Internet. This configuration is shown in both of FIGS. 1A and 1B, where device 140 operates on a private network 130 behind Gateway or other dedicated network appliance 110, and communicates via WAN 120 (such as the Internet) with device 100. Note that device 100 could be a single device on WAN 120, or could be operating on its own private network or according to any other conventional network configuration, as would be apparent. Also note that, because of its location on a private network 130, the IP address of device 140 will not typically be available to device 100.

Modifications of such a Gateway 110 according to one embodiment of the invention are implemented in the establishment of a security association (SA) for an IPsec session between devices 100 and 140, as well as in a forwarding mechanism for the packets being exchanged according to these established parameters.

According to one embodiment of the present invention, a first SA is established between device 100 and Gateway 110. A second SA is established between Gateway 110 and device 140. In this way, Gateway 110 acts as a virtual peer for both devices 100 and 140, and allows device 100 to establish a link with Gateway 110 while believing that the link is actually established with device 140.

It should be understood that Gateway 110 is not merely establishing a link with device 100, decrypting information received thereover, and then re-encrypting the information for transmission over a separate link with device 140. This solution would still suffer from the problem mentioned above that an operator of Gateway 110 would have access to the information contained within the transmission during a time between decrypting and re-encrypting. Rather, actual encryption parameters of devices 100 and 140 are utilized by one another in negotiating a secure connection (e.g, a tunnel) therebetween; however, this negotiation takes place through the Gateway 110.

In other words, in conventional secure connections, devices 100 and 140 would be both SA endpoints and tunnel endpoints, as shown in FIG. 1A. In contrast, according to this embodiment of the present invention, devices 100 and 140 ultimately remain tunnel endpoints, but all of devices 100, 110 and 140 become SA endpoints for two separate SAs, as shown in FIG. 1B.

For example, as will be discussed, Gateway 110 may forward the encryption parameters from device 100 to device 140 and vice-versa, using functionality similar to conventional NAT functionality. As another example mentioned below, Gateway 110 may modify digital certificates of devices 100 and 140 in a manner such that the SA is forced through Gateway 110 even though the devices' actual encryption parameters are still used.

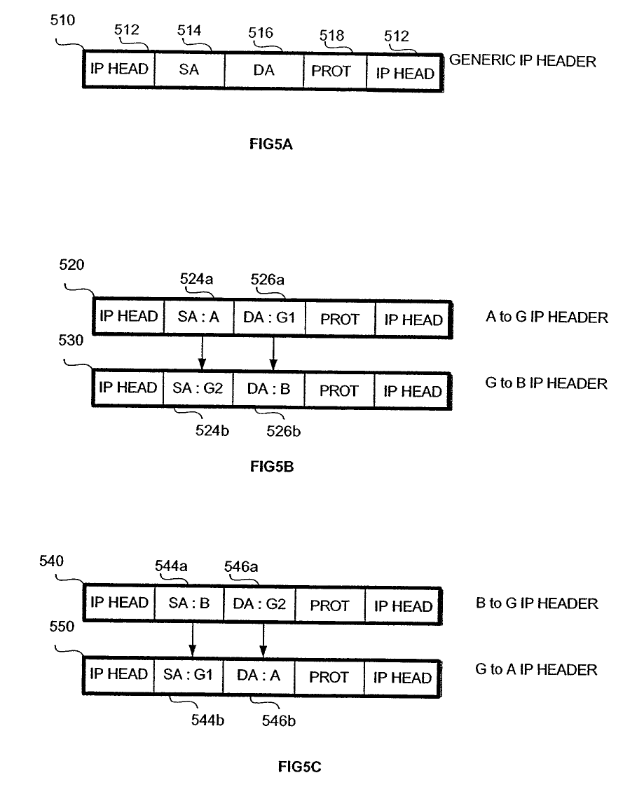

Moreover, once Gateway 110 has assumed such a role in negotiating an SA with a remote peer device, it may also intercept and forward packets more easily and efficiently to devices on the private network 130. For example, device 100 may communicate with several devices on private network 130 after establishing only one SA with Gateway 110. Gateway 110 may swap headers and possibly change the signature of each packet on the fly, as will be discussed with respect to FIG. 5. In addition, Gateway 110 may mediate direct SA negotiation between all of the end devices communicating thereover, thereby controlling all secure communications between the end devices by allowing only (relayed) secure tunnels as discussed herein.

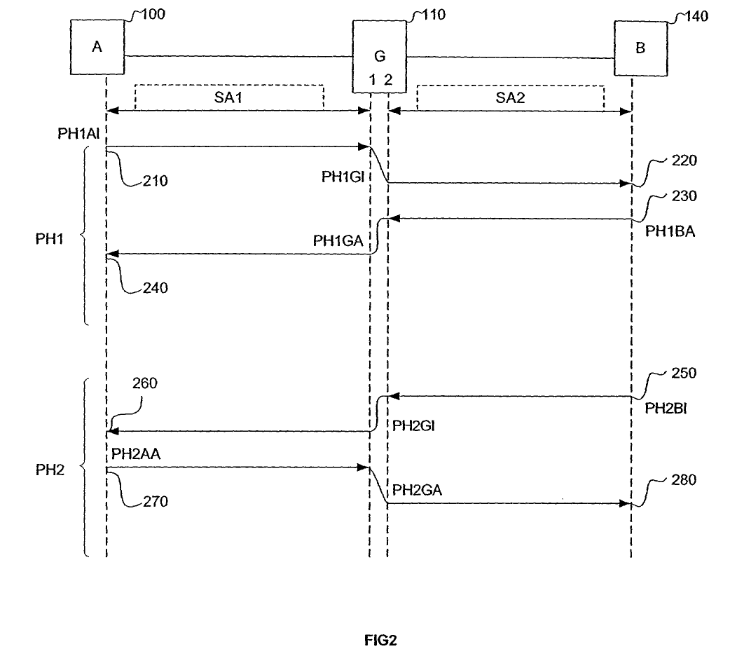

FIG. 2 demonstrates a methodology for negotiating a pair of SAs according to one embodiment of the invention. In FIG. 2, device 100 seeks to initiate an SA with device 140. However, device 100 does not have access to an IP address of device 140. As discussed above, an SA describes operations that should be applied to future data packets including an authentication method, an encryption method (and associated algorithm), authentication/encryption keys and various other parameters (such as the Security Parameter Index (SPI), an effective lifetime of the key(s), etc.). IKE allows two devices to negotiate and agree on these operations, including the establishment of the keys.

As discussed above, there are typically two phases in negotiating an SA using IKE. Thus, in FIG. 2, device 100 initiates a phase 1 session (PH1) by sending message 210 to Gateway 110 at an IP address G1 of Gateway 110 that may be advertised (i.e., made public) over WAN 120.

In one embodiment of the invention, device 100 may be preset such that it believes that address G1 is an address for device 140. In this scenario, Gateway 110 may be aware upon reception of transmission 210 which device with which it will then establish a secondary SA, SA2, without having to inspect the details of the SA transmission 210. This implementation may utilize “loop-back” addresses on Gateway 110, one for each possible peer on private network 130. In other words, there will be a different address G1 associated with each of the private network devices.

Another implementation utilizes a single G1 IP address for all IPsec flows on the WAN side. In this solution, Gateway 110 must examine the transmission 2 10 to determine which private network device will be the tunnel endpoint for communications with device 100. This implementation has the advantage that a device 100 can communicate with a plurality of devices (tunnel endpoints) on private network 130, while only itself needing to establish one SA (with Gateway 110).

In the latter implementation there is a need to maintain a name and identity of device 100, either locally at the Gateway 110 or at a Domain Name System/Server (DNS). This information can also be used to identify device 140 as the sought-after tunnel endpoint device, as will be discussed in connection with FIG. 5.

In any case, phase 1 message 210 is sent from device 100 to Gateway 110 at address G1. This message, as discussed above, is generally intended to protect further negotiation traffic by way of, for example, the Main mode. As is known, the Main mode provides protection for the identity of the involved devices. It is typically divided into three sets of messages, each set containing two messages. The first two messages are used for negotiating a security policy for the exchange, the next two messages are used for the Diffie-Hellman keying material exchange and the last two messages are used for authenticating the peers, such as with digital signatures and optional digital certificates.

It should be noticed that SA2 may start by using a similar message 220 upon reception by Gateway 110 of the first SA1 message. In the various scenarios discussed above, in cases where Gateway 110 does not know the identity of the destination device 140 by one of the above-defined methods, it will wait for a SA message from device 100 containing an identification payload. In such a case, Gateway 110 should proceed with a phase 1 negotiation with device 100 until this message is received.

FIG. 2 describes only the case when either the identity of device 140 is included in the first message 210 or is already known by Gateway 110. One limitation when the destination identity is not known is that Gateway 110 should not start negotiating parameters which may turn out to be unsuitable for device 140; a solution in this case is to define a common set of rules which will be accepted by all devices on private network 130.

Assuming Gateway 110 is aware of the identity of device 140, Gateway 110 may then start a secondary phase 1 SA message 220 for SA2, using another IP address G2 for Gateway 110 that belongs to private network 130 and to which device 140 will be able to answer. Device 140 is now the SA responder and will answer to Gateway 110 using a PH1BA type message 230. In other words, device 140 will receive parameters associated with device 100 but having address G2, and will respond with its own parameters to that address.

Afterwards, Gateway 110 responds to the first SA message 210 and provides a similar answer PH1GA message 240 to device 100. In other words, the same parameters are negotiated between Gateway 110 and device 100 as between Gateway 110 and device 140. The two SAs are thus independent, but will negotiate the same rules and parameters thanks to the interleaving of the SA messages.

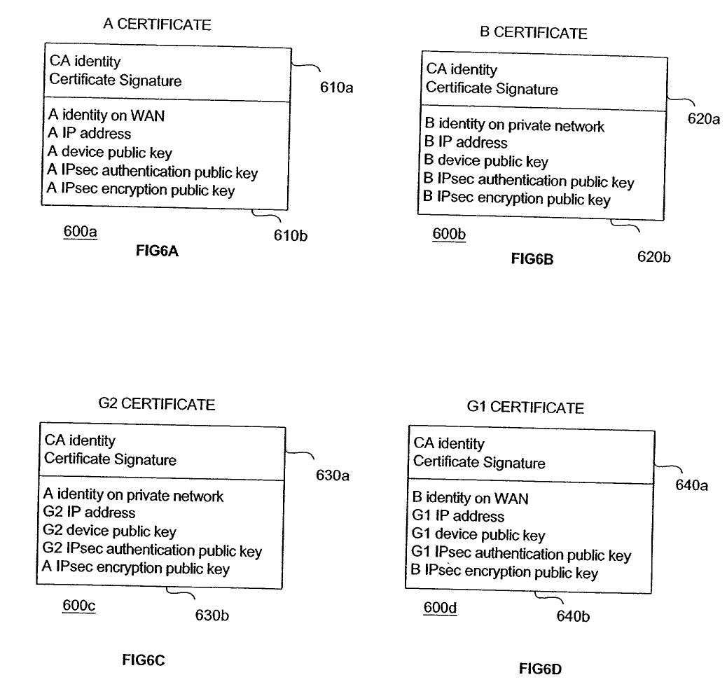

At this point Gateway 110 provides its own authentication parameters, such as its own authentication public key, but uses the identity of device 140. If this checking is done via certificates, then the certificates will be defined according to FIG. 6, as will be discussed. Shared keys (i.e., previously-agreed upon keys designed to be maintained in confidence) may also be used at this point, but do not offer as high a security level as public key encryption.

It should be noted that the SA mechanisms between device 100 and Gateway 110 on one side and device 140 and Gateway 110 on the other side fully meet the IKE protocol rules and process, so that no change is required on devices 100 or 140, which are therefore transparent to this implementation.

Once phase 1 is achieved, a fully secure authenticated channel with possible encryption is established in order to proceed with SA phase 2. Phase 2 allows the definition of parameters for the IPSec protocol itself, and generally makes use of the Quick mode discussed above. A Diffie-Hellman key exchange may be done to achieve forwarding secrecy.

As referred to above, the Diffie-Hellman methodology allows device 100 to build a symmetric secret key (same key used for encryption and decryption) thanks to its local private key, a known Diffie-Hellman (DH) key and the public key of device 140 that can either be transmitted from device 140 to device 100 via Gateway 110, or is obtained from a certificate as described in FIG. 6. Similarly, device 140 builds the same symmetric secret key thanks to its local private key, the DH key and the public key of device 100. As long as the SAs between device 100 and Gateway 110, and between Gateway 110 and device 140, are valid, the same secret key is valid. Therefore the same parameters of key lifetime should typically be negotiated both ways.

Either one of the devices 100 or 140 might initiate the quick mode exchange. In FIG. 2, device 140 is the initiator of the second phase starting with PH2BI message 250. Gateway 110 rebuilds a similar message PH2GI 260, where the authentication (public) key belongs to Gateway 110 and the message is sent to device 100.

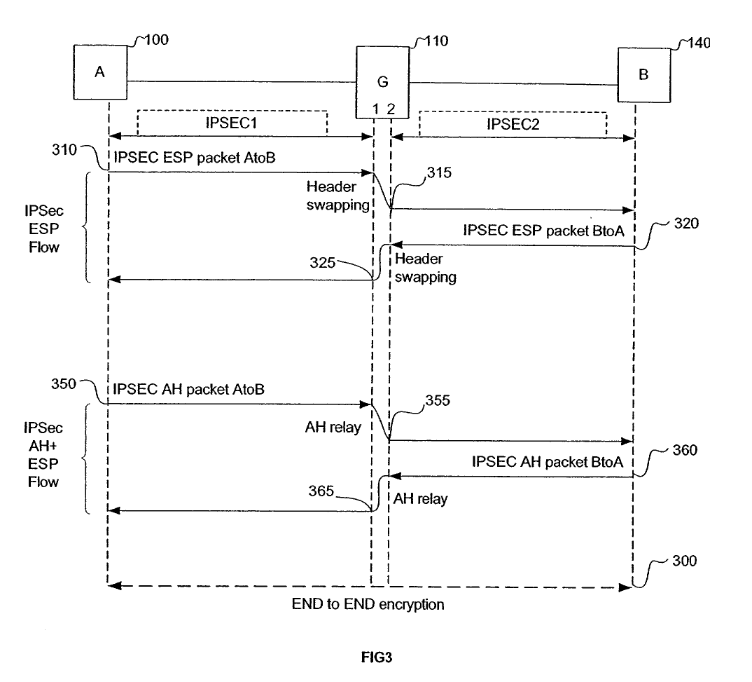

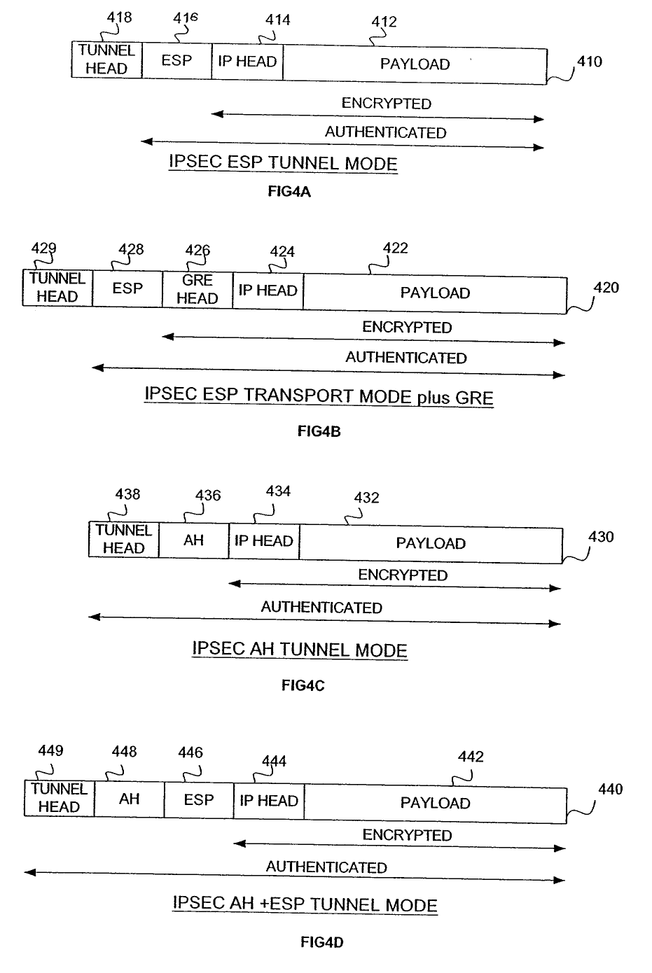

Device 100 answers with its own parameters in PH2AA message 270 to Gateway 110, and the Gateway 110 forwards the message including the same parameter values, except for the authentication key of device 100 which is exchanged for the key of Gateway 110, to device 140 in PH2GA message 280. The authentication key for Gateway 110 given to both of devices 100 and 140 is mainly used when AH header is used in the IPsec flow, in order to allow Gateway 110 to modify the IP header and then rebuild the packet signature, as described with more detail in FIGS. 3 and 4.

A last message that can be viewed as a final acknowledge is also sent back which is not shown in FIG. 2. Such a message ends the SA(s) for IPsec traffic between devices 100 and 140. As SAs are typically asymmetrical, it may be necessary to repeat the above-described process in the reverse direction. However, it may be necessary only to perform a phase 2 negotiation, as is known. Once all SAs are active, the IPsec traffic can start in both directions. Thus a tunnel has been established for future data flows having endpoints of devices 100 and 140, even though the SA endpoints included Gateway 110.

FIG. 3 describes IPsec traffic both ways between devices 100 and 140 through Gateway 110. As just described, Gateway 110 essentially acts as a relay for traffic sent between devices 100 and 140. This relaying function can occur in various ways, depending, for example, on the terms of the SAs previously negotiated. For example, the relay process(es) performed in Gateway 110 may depend on the tunnelling and IPsec protocol headers being used according to the negotiated SAs.

Two exemplary scenarios are represented in FIG. 3: a first scenario where only an ESP header is used (i.e., as explained above, encryption is involved but no fall packet authentication is necessarily provided), and a second scenario where both AH and ESP are used (i.e., when a first IPsec header is an AH header and a second is an ESP header). As already noted, AH may also by used alone without encryption; however, as its behavior is similar to the more complex case when both AH and ESP are used, it is not discussed in detail here.

In FIG. 3, a first IPsec packet is sent from device 100 to Gateway 110 in step 310. As already described, device 100 believes that it is sending a packet to device 140, but the destination address in an IP header of the packet is G1. When Gateway 110 recognizes a packet having G1 as destination address, it first checks a protocol field (“PROT”) field described in FIG. 5 in order to know which process to use. The PROT will indicate whether to use an IPSec ESP flow process or an IPSec AH (+ESP or not) flow. In step 310, the protocol is ESP and therefore Gateway 110 has only to swap source and destination address fields before forwarding the frame to device 140 in step 315. This process is detailed in FIG. 5.

A similar process is used when an IPsec ESP packet is sent by device 140 to device 100 in step 320, requiring header swapping in Gateway 110 and subsequent forwarding of the modified packet to device 100 in step 325.

When the protocol type is identified as AH within a first IPsec protocol header, then the process is a more complex. This scenario is described starting with step 350 by a packet with an IPSec AH header with an IP destination address G1. When Gateway 110 decodes an AH protocol by way of the PROT, the authentication of the packet using its digital signature occurs. This is described in more detail in FIG. 4, along with various other packet structures.

Once authenticated, the AH relay process within Gateway 110 proceeds with the header swapping (as in the previous case), followed by the regeneration of the packet signature using the authentication private key of Gateway 110. Gateway 110 then sends the packet to device 140 in step 355. Device 140 can verify the packet signature using the public key associated with address G2, and which is either certified in a G2 certificate or sent in the SA as being the device 100 authentication public key.

From device 140 to device 100, a similar process is performed starting with the transmission of an IPSec AH packet in step 360 with a destination address of G2. Gateway 110 performs the three steps of authenticating the packet, swapping the header address fields and rebuilding the packet signature. It then forwards the modified IPSec AH packet to device 100 in step 365.

In any of the processes described above, the encryption can be done in either device 100 or 140, and the decryption on device 140 or 100, respectively. Both devices use the same symmetric secret key which may be based on various well-known encryption algorithms built using a Diffie-Hellman public key value and the set of private/public encryption keys associated with device 100 and 140. Gateway 110 doesn't share this encryption secret key, since the encryption private keys of devices 100 and 140 are never disclosed to Gateway 110.

FIGS. 4A-4D describe structures of exemplary IPsec packets that may be transported according to various embodiments of the invention.

In FIG. 4A, packet 410 represents an IPsec packet using IPsec tunnel mode with an ESP header 416. The inner payload 412 and IP header 414 are encrypted, while the entire packet except the tunnel header 418 is authenticated (i.e. integrated in the packet signature). Therefore, a change in the tunnel header 418 may be done without an impact on the packet authentication.

In FIG. 4B, packet 420 represents an IPsec packet using IPsec transport mode with ESP header 428 and Generic Routing Encapsulation (GRE) tunneling. The inner payload 422 and IP header 424 as well as the GRE portion 426 are encrypted, while the entire packet except the tunnel header 429 is integrated in the packet signature (i.e., authenticated). Therefore, a change in the tunnel header 429 may be done without an impact on the packet authentication. This case uses the same header process swapping as a packet 410 shown in FIG. 4A.

In FIG. 4C, packet 430 represents an IPsec packet using IPsec tunnel mode with AH header 436. No field is encrypted, while the entire packet including the tunnel header 438 is integrated in the packet signature. Therefore, a change in the tunnel header 438 cannot be done without an impact on the packet authentication. The process in Gateway 110 therefore includes the three steps described above of authenticating the packet, swapping the header address fields and rebuilding the packet signature (i.e., re-authenticating).

In FIG. 4D, packet 440 represents an IPsec packet using IPsec tunnel mode with AH and ESP headers 448 and 446, respectively. The inner payload 442 and IP header 444 are encrypted, while the entire packet including the tunnel header 449 is integrated in the packet signature. Therefore, as in FIG. 4C, a change in the tunnel header 449 cannot be done without an impact on the packet authentication, and the three-step process of authenticating the packet, swapping the header address fields and rebuilding the packet signature must again be performed within Gateway 110.

FIG. 5 demonstrates various simplified views of IP header packet structures for tunnel head portions such as portions 418, 429, 438 and 449 shown in FIGS. 4A-4D.

As shown in FIG. 5A, the tunnel head is an IP header which contains different fields as shown in generic IP header 510. The fields include IP header trailer/footer fields 512, as well as a source address field SA (514), a destination address field DA (516) and a protocol field PROT (518).

FIG. 5B demonstrates a first header-swapping process as a packet is sent from device 100 through Gateway 110 to device 140. Specifically, packet 520 demonstrates a source address A in source address field 524a, indicating origination at device 100, and a destination address G1 in source address field 526a, indicating a destination of Gateway 110. As packet 520 is relayed through Gateway 110, source address field 524b is switched to contain a new source address of G2, while destination address 526b field is switched to contain a destination address B.

Similarly, FIG. 5C demonstrates a second header-swapping process as a packet is sent from device 140 through Gateway 110 to device 100. Here, packet 530 demonstrates a source address B in source address field 544a, indicating origination at device 140, and a destination address G2 in source address field 546a, indicating a destination of Gateway 110. As packet 530 is relayed through Gateway 110, source address field 544b is switched to contain a new source address of G1, while destination address 546b field is switched to contain a destination address A.

If there is a one-to-one mapping between device address A and G1 on one side, and device address B and G2 on the other side, the process is easily-implemented. However, it is also possible to share a single G1 address between several devices located on WAN 120 and/or share a single G2 address between several devices located on private network 130. In that case, a local or remote directory table should be use to identify, based on the source address, which IPsec peer corresponds to this flow. It may be a table built during the SA phase, a static directory or a dynamic directory using either a DNS server or a digital certificate from a certification authority server. However, all of the above methods will typically have the restriction that only one destination may be linked to a particular source address.

FIG. 6 describes exemplary certificate structures for each device type when certificates are used within the SA process. The certificates 600a and 600b for devices 100 and 140 in FIGS. 6A and 6B can be standard or “true” certificates, as all the parameters included in the certificate fields really belong to those devices. A certificate 600a for device address A as in FIG. 6A is only given to a device located on WAN 120, and a certificate 600b for device address B as in FIG. 6B is only given to a device located on private network 130.

As shown in FIG. 6A, a portion 610a of certificate 600a may contain the certification authority (CA) identify and signature, while a portion 620a contains various information for device 100 having address A, including its identity on the WAN 120, IP address, device public key, IPsec authentication public key and IPsec encryption public key.

Similarly, as shown in FIG. 6B, a portion 610b of certificate 600b may contain the CA identify and signature, while a portion 620b contains various information for device 140 having address B, including its identity on the private network 130, IP address, device public key, IPsec authentication public key and IPsec encryption public key.

FIG. 6C demonstrates a type of certificate 600c that a device 140 having device address B (or a similarly-situated device) may receive when it requests a certificate for a device such as device 100 having device address A (or a similarly-situated device). A certificate such as 600c is a “false” certificate, since it is validated by the CA as valid even though it contains some fields with false information in order to work properly. That is, if certificate 600c is considered to belong to Gateway 110, then Gateway 110 is impersonating device 100 having address A in purporting to possess that device's identity (as far as the private network 130 is concerned) and public encryption key.

Alternatively, if certificate 600c is considered to belong to device 100, then it can be considered a “hybrid” true-false certificate since the identity and public encryption key are correct but the remaining fields (i.e., IP address, device public key and IPsec authentication public key) are incorrect. Nevertheless, it should be noted that such certificates are valid certificates that can easily be built by the network security administrator.

Similar comments apply in the inverse to certificate 600d in FIG. 6D; that is, it represents a type of certificate 600d that a device 100 having device address A may receive when it requests a certificate for a device such as device 140 having device address B.

Note that although Gateway 110 may have different device addresses G1 and G2 as discussed, which is proper inasmuch as those addresses belong to separate networks, a G2 device public key and IPsec authentication public keys may be the same as corresponding keys for the G1 address.

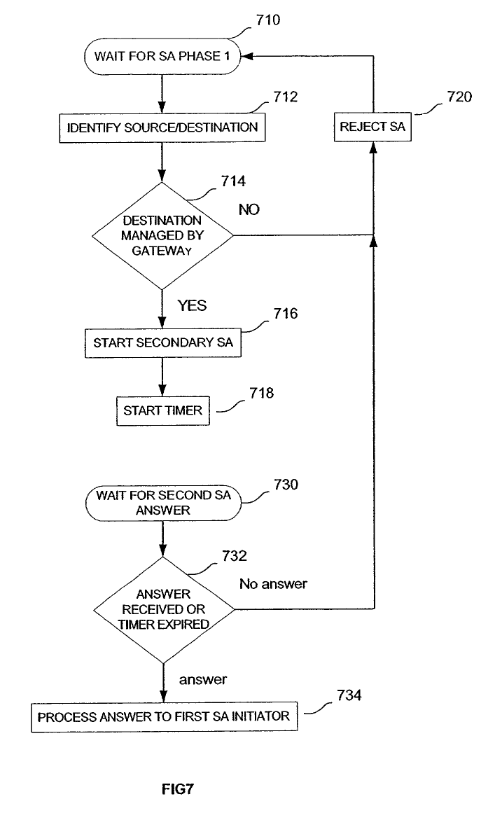

FIG. 7 demonstrates exemplary process steps run by Gateway 110 during SA establishment. Note that, at each step, the process may stop if an error or a wrong request is performed which leads to a rejection of the SA. However, this is not shown at each step in order to simplify the process; only steps where there is a high probability of rejection are shown as such.

In step 710, Gateway 110 waits for a phase 1 SA message to be detected from either the WAN 120 interface or the private network 130 interface. Note that any new SA is considered a separate process, so that only one such process is detailed here. When an SA message with a new source IP address is decoded, then a source and destination address is determined in step 712. As already mentioned, a source address of an SA initiator may be included in the message or may be searched by Gateway 110 using a DNS lookup or a Certificate request to the appropriate CA.

If the identity is recognized and allowed to establish an IPsec session with a device located on the opposite network, the process goes to step 714. In step 714, the IP destination of the SA message is checked, including verification that it is a valid destination for IPsec and that this destination is reachable and active.

Gateway 110 may also validate the destination according to the source, using entity certificate comparison and validation. For example, if the two entities do not belong to the same company or VPN, the SA may be rejected according to predefined rules. In case of rejection, the process stops on step 720, which may include a rejection message to the initiator of the message or not, whereupon Gateway 110 goes back to its waiting state 710.

If the destination 1P address and identity is allowed as a destination with respect to the IP source address and associated identity, then the process in step 716 starts, as an SA originator, a secondary phase one Security association. The process also, in step 718, starts a timer and then waits for an answer to this message in step 730.

In step 732, if no answer is received due to either a timer expiration, a bad answer or a rejection answer then the first SA is rejected in step 720. If an acceptable answer is received, then the answer is analyzed and processed in step 734 according to the IKE (ISAKMP) standard. In this case, an affirmative answer is also provided to the first SA initiator device in step 734.

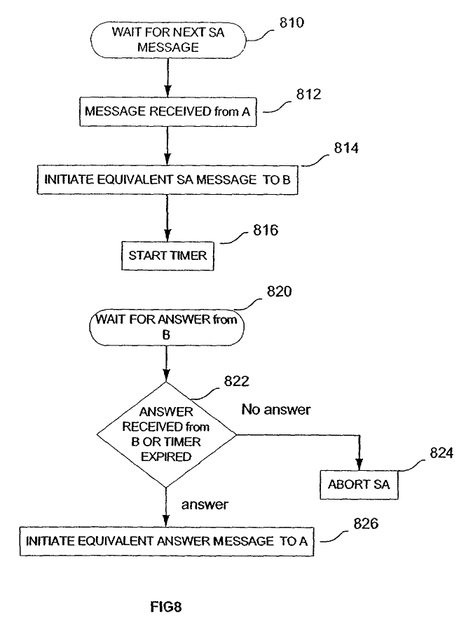

FIG. 8 describes other SA messages as handled by Gateway 110. These include other phase 1 messages as well as SA phase two messages according to ISAKMP/IKE. To the extent that the first and secondary Security Associations fully meet the ISAKMP and IKE standard recommendations, they are not further detailed. FIG. 8 only refers to parameters that are exchanged that are different from the standard process(es).

In step 810, Gateway 110 awaits additional SA messages. When an SA message from an existing session arrives in step 812 (such as from device 100 having device address A), Gateway 110 analyzes the content of the message and prepares a similar request to the other SA peer device on the other network (such as device 140 having device address B) in step 814.

Next, a timer is started in step 816 and Gateway 110 begins to wait for an answer from device 140 in step 820. If no answer is received before the timer expires in step 822, the session can be aborted in step 824. When an answer is received in step 822, the process proceeds to step 826, where an equivalent answer is built and sent to the first message initiator (A in the described example).

Thus, as can be seen from the above description, the present invention provides a methodology for providing a private, secure connection between devices, even when one of the devices is located on a private network such that its device address is not publicly available. In one embodiment, the present invention operates by providing a first secure connection between a first device and a gateway to the private network, and thereafter providing a second secure connection between the gateway and the second device. Once various security, authentication and/or encryption parameters are exchanged via the two connections, communications between the two devices may take place. In this way, neither end point device need know an actual address of the other device. Additionally, once a first secure connection is established between the first device and the gateway, a plurality of secondary secure connections can be implemented between the gateway and a each of a plurality of devices connected to the private network. In this way, network management is improved.

While this invention has been described in various explanatory embodiments, other embodiments and variations can be effected by a person of ordinary skill in the art without departing from the scope of the invention.

What is claimed is:

1. A method for implementing secure network communications between a first device and a second device, at least one of the devices communicating with a public network via a separate computer, the method comprising:
receiving a request for a first secure connection from the first device;
masking an address of the first device with respect to the second device; and
initiating a second secure connection between the separate computer and the second device,
wherein the first and second secure connections enable the secure network communications between the first and second devices.

2. The method of claim 1, wherein the first secure connection is a security association negotiated using a device address of the first device and a first device address of the separate computer.

3. The method of claim 2, wherein the second secure connection is a security association negotiated using a second device address of the separate computer and a device address of the second device.

4. The method of claim 3, further comprising:
relaying the secure communications between the first and second devices,
wherein communications from the first and second devices are received at the first and second device address, respectively, of the separate computer.

5. The method of claim 3, further comprising:
maintaining a table relating the device addresses of the two devices and the device addresses of the separate computer; and
forwarding the secure communications between the first and second devices based on the table.

6. The method of claim 1, further comprising:
communicating the device addresses of the first and second device between the two, via the first and second secure connections; and
forwarding the secure communications using the respective device addresses of the first and second devices.

7. The method of claim 1, wherein said first and second secure connections are separate security associations, and further comprising:
forwarding encryption parameters of the two devices between the two devices in order to establish the security associations.

8. The method of claim 1, further comprising:
swapping a source and destination address contained within a packet received from the first device such that the packet is forwarded to the second device.

9. A virtual peer device for implementing a secure network connection between a first and second device, at least one of the devices being a private network device communicating with a public network via the virtual peer device, the virtual peer device comprising:
means for receiving a request for a first connection from the first device;
means for requesting a second connection with the second device;
means for forwarding encryption parameters between the two devices, to thereby establish the first and second connections; and
means for establishing the secure connection based on the first and second connections.

10. The virtual peer device of claim 9, further comprising:
means for relaying data between the two devices via the secure network connection.

11. The virtual peer device of claim 10, further comprising:
a device address to which the first and second devices direct communications when requesting and establishing the first and second connections.

12. The virtual peer device of claim 11, further comprising:
a public key for authenticating packets forwarded by the virtual peer device.

13. The virtual peer device of claim 9, wherein the first and second connections are security associations negotiated as part of an IPsec session.

14. An article of manufacture, which comprises a computer readable medium having stored therein a computer program carrying out a method for implementing a secure connection between two devices, the computer program comprising:
a first code segment for establishing a device address associated with the article of manufacture;
a second code segment for establishing a first link between a first device and the device address;
a third code segment for establishing a second link between a second device and the device address;
a fourth code segment for exchanging encryption parameters associated with each of the first and second device via the first and second link; and
a fifth code segment for establishing the secure connection based on the encryption parameters.

15. The article of manufacture of claim 14, wherein at least one of the devices is located on a private network, and further wherein the article of manufacture is a gateway device on the edge of the private network.

16. The article of manufacture of claim 14, further comprising:
a sixth code segment for relaying communications between the two devices over the secure connection, via a virtual link having the two devices as endpoints.

17. The article of manufacture of claim 14, further comprising:
a sixth code segment for associating the device address associated with the article of manufacture as a device address of the second device.

18. The article of manufacture of claim 14, wherein the first and second links have the same encryption parameters.

19. A method of transmitting data, comprising:
negotiating a first security association between a first device and a second device;
negotiating a second security association between a second device and a third device that is independent of the first security association; and
transmitting data inaccessible to said second device between the first and third devices via the second device.

20. The method of claim 19, further comprising:
constructing an encryption secret key shared only by the first and third devices that enables the first and third devices to encrypt and decrypt the data transmitted therebetween.

21. The method of claim 20, wherein the data comprises data packets, and further wherein a first portion of the data packets is encrypted using the encryption secret key and a second portion of the data packets is authenticated using a digital signature.

22. The method of claim 21, wherein the second device redirects the data packets by exchanging, in a header portion of each data packet, a device address of a one of the first and third devices that is to receive the data for its own device address.

23. The method of claim 19, wherein said transmitting further comprises:
receiving data from the first device at the second device;
authenticating the data as having been transmitted from the second device; and
transmitting the data to the third device.

24. The method of claim 23, wherein said receiving data from the first device at the second device further comprises:
authenticating the data as having been transmitted from the first device; and
exchanging, in a header portion of a packet containing the data, an address of the second device for an address of the third device.
